(19) United States
(12) Patent Application Publication
(10) Pub. No.: US 2026/0145193 A1
(43) Pub. Date: May 28, 2026

(54) DEVICE FOR DISPENSING A FLUID SUBSTANCE

(71) Applicant: LUMSON S.P.A., CAPERGNANICA (IT)

(72) Inventor: Matteo MORETTI, Crema (IT)

(21) Appl. No.: 19/397,600

(22) Filed: Nov. 21, 2025

(30) Foreign Application Priority Data
Nov. 26, 2024 (IT) 102024000026583

(51) Int. Cl. B05B 11/10; B05B 11/00

(52) U.S. Cl. CPC B05B 11/1047; B05B 11/0038; B05B 11/1028

(57) ABSTRACT

A device (1) for dispensing a fluid substance comprising an outer container (2) made of a high-quality material, the outer container (2) being endowed with a first neck (2A), the first neck determining a first thread (4), an intermediate element (3) equipped with a mating or counter-thread (3A) that couples to the first thread (4), the intermediate element (3) determining a second neck (5), a deformable bag (6) which is housed in the outer container (2), the deformable bag (6) determining a first flange (6A) that rests on the second neck (5) of the intermediate element, a pump (7) that is at least partially inserted in a sealed manner into the deformable bag (6) and is equipped with a second flange (7A) that rests on the first flange (6A) of the deformable bag (6) and a ring nut (8) that is mounted on the second neck (5) of the intermediate element (3), the neck (5) and the ring nut (8) featuring, respectively, fixing means (9) and fixing counter-means (10) which cooperate so as to mutually secure the ring nut to the intermediate element (3), the first flange (6A) of the deformable bag (6) and the second flange (7A) of the pump (7) being sandwiched between the second neck (5) and the ring nut (8).

### CROSS REFERENCE TO RELATED APPLICATIONS

This application claims priority from Italian patent application no. 102024000026583, filed Nov. 26, 2024, the contents of which is incorporated herein by reference.

### FIELD OF THE INVENTION

The present invention relates to a device for dispensing a fluid substance.

In particular, the present invention relates to a device for dispensing a fluid substance housed in a deformable bag contained, in turn, in an outer container made of a high-quality material which is reusable by refilling.

### BACKGROUND ART

There are commonly known systems that comprise an outer container made of glass or a further high-quality material, inside which a deformable bag is housed.

Some of these systems are designed to be refillable but it is not easy for the end user to perform this operation.

WO2012/066716 A1 describes a device known in the art.

### SUMMARY OF THE INVENTION

The object of the present invention is to provide a device for dispensing a fluid substance which is improved compared with the prior art.

Another object of the invention is to provide a device for dispensing a fluid substance that allows quick and easy refilling by a user.

This and other objects are achieved by means of a device for dispensing a fluid substance produced according to the technical teachings of the appended claims.

### BRIEF DESCRIPTION OF THE FIGURES

Further features and advantages of the innovation will become clearer in the description of a preferred but not exclusive embodiment of the device, illustrated-by way of a non-limiting example-in the drawings appended hereto, in which:

FIG. 1 is a simplified axial sectional view of a device according to the invention;

FIG. 2 is a simplified axial sectional view of some parts of the device in a variant of the invention; and

FIG. 3 is an axial sectional view of some parts of the device in a further variant of the present invention.

### DETAILED DESCRIPTION OF THE INVENTION

With reference to the figures stated, reference number 1 is used to denote, as a whole, a device for dispensing a fluid substance.

The device 1 for dispensing a fluid substance comprises an outer container 2 made of a high-quality material.

The fluid substance may be of any cosmetic or medical type which can be dispensed via a manually operated pump 7, such as a cream, soap, lotion, etc.

The outer container 2 is preferably made of a high-quality material, and it is formed in a single piece.

In this text, ‘high-quality material’ may be understood to mean glass (which may also be painted and/or decorated internally or externally with reliefs or recesses), ceramic, metal, etc. and in any case, a material that is aesthetically appealing due to the cost, finish, or workmanship thereof and is intended to be reused.

The outer container 2 features a plant-view shape which can be circular, oval, square, or quadrangular in shape.

The said container preferably extends further in height than in width, taking on a long, elongated shape, for example a bottle shape.

The outer container 2 may be cup-shaped.

The outer container 2 is equipped with a first neck 2A.

The first neck determines a first thread 4, which is preferably made integrally with the outer container 2.

Next, there is an intermediate element 3 present that is equipped with a mating or counter-thread 3A, which mates with the first thread 4.

The intermediate element 3 determines, in turn, a second neck 5.

Advantageously, the second neck 5 determines an opening with an area that is significantly smaller than the area of the opening A determined by the outer container 2.

For example, the area of the neck 5 opening may be between ½ and ¼, preferably ½, of the area of the outer container opening A.

Housed inside the outer container 2 is a deformable bag 6. The deformable bag 6 determines a first flange 6A (which may be shaped) that rests on the second neck 5 of the intermediate element.

Inserted at least partially into the deformable bag 6 (and/or into the neck 5 of the intermediate element 3, via the neck of the deformable bag 6) there is a pump 7, which is preferably airless.

The pump 7 may be connected to the bag in a sealed manner, for example, via an O-ring 23 (or other type of gasket).

The pump 7, in order to be operated, may be connected to a dispensing button 20.

The pump 7 is equipped with a second flange 7A that rests on the first flange 6A on the deformable bag 6.

There is also a ring nut 8 present, mounted on the second neck 5 of the intermediate element 3.

The ring nut 8 can be coupled, for example by snap-fitting, to a removable cap 21 which, when positioned on the ring nut 8, covers and protects the dispensing button 20.

The neck 5 and the ring nut 8 feature, respectively, fixing means 9 and counter-means 10 that cooperate in order to mutually secure the ring nut to the intermediate element 3.

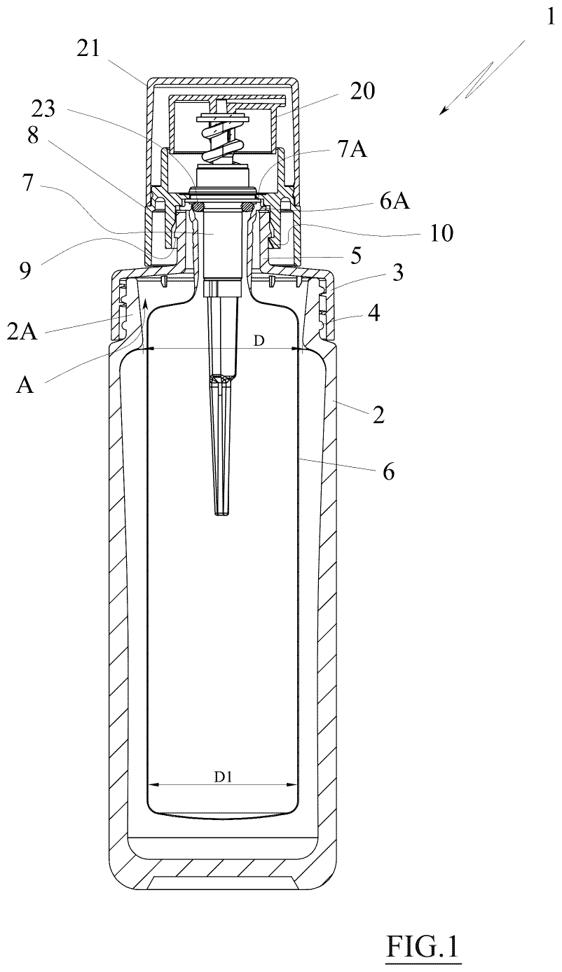

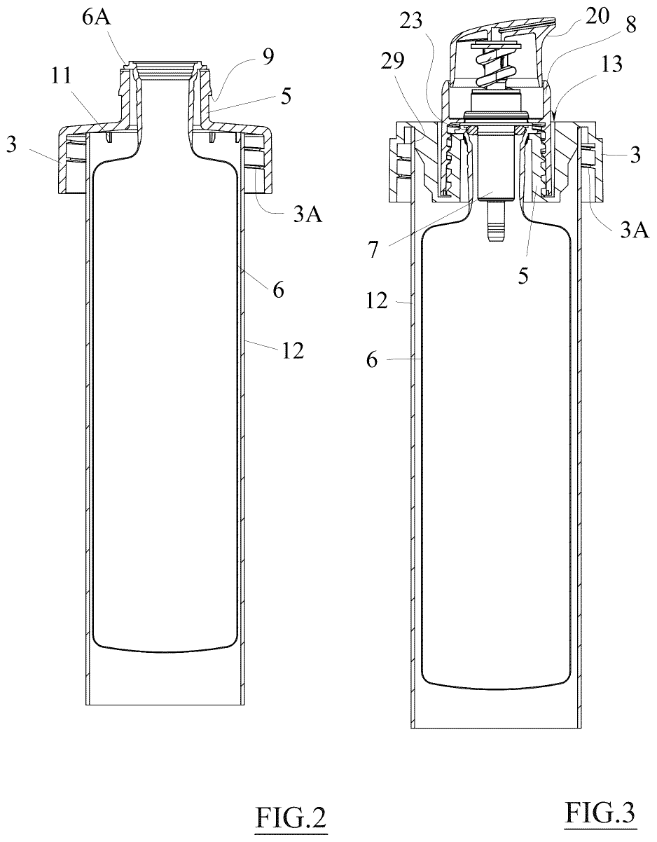

The said means 9 and counter-means 10 can determine a snap-fit coupling, as shown in FIG. 1.

In this case, the means 9 may comprise a (preferably continuous) annular tooth and the counter-means 10 may comprise a (continuous or discontinuous) mating tooth that snap-fits into the annular tooth, engaged by an undercut feature.

It is also possible that the said means 9 and counter-means 10 are mutually engaged threads, as shown for example in FIG. 3. Note that in FIG. 1, instead of the annular tooth and the mating tooth, threads may be envisaged.

If threads are present, there are also stroke limit devices or thread-locking systems that prevent or make it difficult for the end user to unscrew the ring nut 8.

With the configuration described above, it should be noted that the first flange 6A on the deformable bag 6 and the second flange 7A on the pump 7 are sandwiched between the second neck 5 and the ring nut 8, and are therefore securely fastened.

Advantageously, the first neck 2A determines an opening A configured so as to allow the deformable bag 6 to be inserted into the container when the deformable bag 6 is full.

For example, the first neck 2A can determine an opening A with a minimum diameter D which is greater than the maximum diameter D1 of the bag 6 when the said bag is full of the said substance.

For example, the diameter D can be between 20 mm and 40 mm.

In this way, when the bag 6 is empty, it is possible to unscrew the ring nut 3 from the outer container 2 (therefore, together with the old bag) and fit a new intermediate element 3 on the outer container 2, which is already associated with a full deformable bag 6 and already features both the pump 7 and the ring nut 8. Obviously, the bag 6 is inserted into the outer container.

Advantageously, the pump 7 snap-fits onto the said ring nut 8. This facilitates industrial assembly thereof.

For this purpose, the pump 7 may include a groove (in this configuration, just above the flange thereof) that fits into a calibrated hole (with a continuous or discontinuous perimeter) in the ring nut 8.

To protect the deformable bag 6, for example, during transportation of the refill, the intermediate element 3 may comprise a system 11 for coupling a protective element 12 to the deformable bag 6, the protective element 12 being preferably a cardboard, plastic, or aluminium element.

The protective element 12 may be high enough to completely cover the deformable bag 6, surrounding the latter, or envelop the deformable bag 6 or may even, as shown in the figure, exceed the maximum height thereof.

In this case, the protective element 12 can determine a lower support surface by means of which the refill can be positioned on a flat surface, without the deformable bag coming into contact therewith, which could result in damage.

Finally, the protective element 12 can also optionally comprise a bottom, so as to completely isolate the deformable bag 6.

Advantageously, the protective element 12 is a tubular element.

For example, the system 11 for coupling the intermediate element 3 may comprise ribs that extend from one of the shoulders thereof and engage with an internal diameter of the protective element 12.

Alternatively, as shown in FIG. 3, the protective element 12 may engage with a (specifically envisaged) cylindrical portion 29 of the intermediate element 3.

To conclude the description, it should be noted, with reference to FIG. 3, that the ring nut 8 may be at least partially inserted into a groove 13 determined by the intermediate element 3.

Advantageously, the groove 13 may have a considerable depth, for example, allowing the entire height of the neck 5 of the intermediate element 3 to be completely or almost completely enclosed therewithin.

According to one aspect of the invention, however, the system envisages that the pump can be unscrewed manually after use, thereby maintaining at least a minimal gripping surface (on the ring nut 8, on the intermediate element 3, or on the pump) which is exposed.

Various embodiments of the innovation have been disclosed herein, but further embodiments may also be conceived using the same innovative concept.

1. A dispensing device of a fluid substance comprising:
an outer container made of a valuable material and formed in a single piece, the outer container being provided with a first neck, the first neck defining a first thread;
an intermediate element provided with a counter-thread matching the first thread, the intermediate element defining a second neck;
a deformable bag housed in the outer container, the deformable bag defining a first flange resting on the second neck of the intermediate element;
a pump at least partially inserted, sealedly, into the deformable bag and having a second flange resting on the first flange of the deformable bag; and
a ring nut mounted on the second neck of the intermediate element, the second neck and the ring nut having fixing means and fixing counter-means, respectively, cooperating to mutually secure the ring nut to the intermediate element, the first flange of the deformable bag and the second flange of the pump being sandwiched between the second neck and the ring nut, the first neck defining an opening configured to allow insertion of the deformable bag into the container when the deformable bag is full.

2. The device according to claim 1, wherein the first neck defines an opening having a minimum diameter greater than the maximum diameter of the bag when it is full of said substance.

3. The device according to claim 1, wherein the pump is snap-coupled to said ring nut.

4. The device according to claim 1, wherein said fixing means and fixing counter-means are threads.

5. The device according to claim 1, wherein said fixing means and fixing counter-means define a snap fit coupling.

6. The device according to claim 1, wherein the intermediate element comprises a coupling system of a protective element of the deformable bag.

7. The device according to claim 6, wherein the protective element is a tubular element.

8. The device according to claim 6, wherein the coupling system comprises ribs extending from the intermediate element and engaging an inner diameter of the protective element.

9. The device according to claim 1, wherein the ring nut is at least partially inserted in a groove defined by the intermediate element.

10. The device according to claim 6, wherein the protective element comprises a cardboard.
